(19) United States
(12) Patent Application Publication
(10) Pub. No.: US 2009/0014962 A1
(43) Pub. Date: Jan. 15, 2009

(54) MULTI-LAYERED SEAL

(76) Inventors: Lyman Scott Ducworth, Baden-Wurttemburg (DE); Christopher Couchell, Spartanburg, SC (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/171,567

(22) Filed: Jul. 11, 2008

Related U.S. Application Data
(60) Provisional application No. 60/949,380, filed on Jul. 12, 2007.

(51) Int. Cl. F16J 15/32

(52) U.S. Cl. 277/309; 277/402

(57) ABSTRACT

A seal for static and dynamic sealing of a space between two surfaces. The seal includes a radial inner end defining a radial inner surface, a radial outer end defining a radial outer surface, a first axial end face, and a second axial end face, the radial inner end having a width narrower than the width of the radial outer end. The seal may have an annular recess extending around the circumference of the seal. When the radial inner surface is disposed about first surface, the seal is rollable about an edge of the radial inner end such that one of the first axial end face and the second axial end face is disposed against the first surface, and the opposite axial end face is oriented toward and compressible against the second surface.

### CROSS-REFERENCE TO RELATED APPLICATIONS

The present application claims the benefit of the filing date of U.S. Provisional Application Ser. No. 60/949,380, filed Jul. 12, 2007, which is incorporated by reference in its entirety.

### TECHNICAL FIELD

The present invention provides seals for use in static or dynamic applications. In particular, the present invention provides a seal for sealing applications where multiple sealing characteristics or properties are desirable.

### BACKGROUND

Dynamic and static seals are used in a wide variety of sealing applications. Seals may be provided that exhibit particular characteristics suitable for a particular application. In some applications, it may be desirable for the seal to exhibit good sealing at low temperatures, e.g., at sub zero temperatures and even in the range of −40° F. or below. At low temperatures, some materials may become stiff and contract, such that fluids may seep through the seal/surface interface. That is, some materials may not exhibit sufficient elasticity at low temperatures to maintain a fluid seal between the surfaces. The seepage may stop when the system warms up and the seal regains its flexibility and expands to reseat itself. Materials that do not significantly stiffen or contract at low temperatures such that they exhibit good sealing at low temperatures are said to have good low-temperature performance.

In other applications, it may be desirable for a seal to be relatively impermeable to a particular fluid, i.e., the seal exhibits low permeability to a fluid. Low permeability to fluids such as automotive fuel and fluids may be desirable in automotive applications such as in automotive supply lines, gas tanks, etc.

In some applications, the seal must exhibit both good sealing low-temperature performance (i.e., low leakage) and low permeability. However, materials that provide or exhibit a particular seal property or characteristic may not provide the other desired property or characteristic. For example, materials that exhibit low permeability to a given fluid may have poor low-temperature performance and materials that exhibit good low-temperature performance may not exhibit low permeability to the fluid.

### SUMMARY

The present invention provides a seal for providing a fluid seal between two surfaces. The seal may be used in static and dynamic sealing applications. The present invention provides a seal that may exhibit a plurality of seal properties or characteristics desirable for a particular application at each sealing interface.

According to one aspect of the invention, a seal for sealing a space between two surfaces comprises an elastomeric body having a radial inner end defining a radial inner surface, a radial outer end defining a radial outer surface, a first axial end face, and a second axial end face, the radial inner end having a width narrower than the width of the radial outer end. The seal, when its radial inner surface is disposed about the first surface, is rollable about an edge of the radial inner end such that one of the first axial end face and the second axial end face is disposed against the first surface, and the opposite axial end face is compressible against the second surface.

The seal may comprise an annular recess extending around the circumference of the seal and define a first sealing arm adjacent the first axial end face and a second sealing arm adjacent the second axial end face. When the seal is installed between the first and second surface such that the second axial end face is compressed against the second surface, the second sealing arm may be deflected radially inward.

The seal may be a multi-layered construction having an inner layer and an outer layer adjacent the inner layer. The inner layer defines the inner radial surface, and the outer layer defines the outer radial surface. The inner layer may be formed from a first material and the outer layer may be formed from a second material. The first material may provide a first seal characteristic or property, and the second material may provide a second seal characteristic or property. For example, the first material may have a permeability to a given fluid that is lower than the permeability of the second material to the given fluid, and the second material may exhibit better low temperature elasticity than the first material.

In one aspect, the present invention provides a method of sealing a space between two surfaces using a seal in accordance with various aspects of the present invention.

The present invention provides a seal that is suitable for providing a plurality of seal properties or characteristics at each sealing interface. In particular, unlike multi-layered seals where only one material contacts a particular sealing interface or one material contacts each sealing interface (e.g., where an outer layer encapsulates an inner layer) the present invention provides a seal wherein each material forming the respective layers of the seal can be provided at each sealing interface. In particular, where the materials forming the respective layers exhibit different properties or characteristics desirable for a particular sealing application, a seal in accordance with the present invention provides a construction whereby, when installed, the respective materials of the respective layers may be provided at each sealing interface and thereby provide each property or characteristic at each sealing interface.

In one aspect, the present invention provides a part designed for radial sealing applications where low temperature elasticity and low permeation are both application requirements. The seal may be comprised of a fluorocarbon layer as well as a nitrile layer of material and is configured in a manner that allows the sealing profile to roll onto its side during installation to reorient the seal such that each of the two layers contact the respective sealing interfaces to provide both low permeation and low temperature elasticity features along each sealing interface. The seal is capable of compensating to large clearance gaps because of its configuration and also does not require large levels of insertion force.

Further features of the invention will become apparent from the following detailed description when considered in conjunction with the drawings.

### BRIEF DESCRIPTION OF THE DRAWINGS

In the annexed drawings:

FIG. 1 is a perspective view of an exemplary seal according to the present invention;

FIG. 2 is an axial end view of the seal of FIG. 1;

FIG. 3 is a cross-sectional view of the seal of FIGS. 1 and 2 taken along the line A-A;

FIG. 4 is a detailed view of section B of FIG. 3;

FIG. 5 is a schematic illustration of an exemplary seal disposed about a surface of a first member prior to sealing a space in a bore hole;

FIG. 6 is a schematic illustration of an exemplary seal disposed about a surface of a first member prior to sealing a space in a bore hole, an end surface of the seal being rolled toward the surface of the first member; and

FIG. 7 is a schematic illustration of an exemplary seal employed in a sealing relationship with a first surface of a first member and a surface of a second member.

### DETAILED DESCRIPTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” and “axial” referring, respectively, to directions perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

All ranges and ratio limits disclosed in the specification and claims may be combined in any manner. It is to be understood that unless specifically stated otherwise, references to “a”, “an”, and/or “the” may include one or more than one and that reference to an item in the singular may also include the item in the plural. All combinations specified in the claims may be combined in any manner.

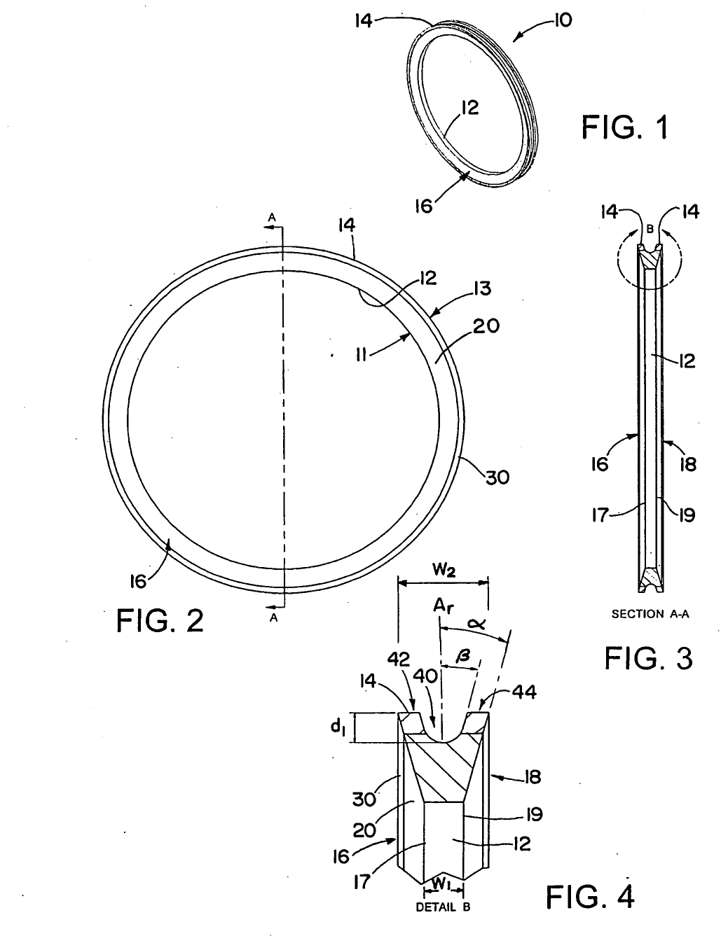

Referring now to the detailed drawings, FIGS. 1-4 illustrate an exemplary seal in accordance with the present invention. As shown in FIGS. 1-4, a seal 10 includes a radial inner end 11 having a radial inner surface 12, a radial outer end 13 having a radial outer surface 14, a first axial end face 16, and a second axial end face 18. The seal has a radial axis Aᵣ. The radial inner end has a width W₁ narrower than the width W₂ of the radial outer end. As such, the axial end faces 16 and 18 are angled at first and second angles α, respectively, relative to the radial axis Aᵣ.

The angle(s) α may be selected as desired for a particular application. The angles of the first axial end face and the second axial end face may be the same or different. The angle α may be, for example, from about 5° to about 85°, or from about 20° to about 60°. An exemplary angle may be, for example, about 30°.

The seal in FIGS. 1-4 is shown as having a multi-layered construction. The seal 10 is a bi-laminate construction that includes an inner layer 20 and an outer layer 30. The inner surface of the inner layer 20 defines the radial inner surface 12. The outermost surface of the outer layer 30 defines the radial outer surface 14. It will be appreciated that a multi-layered seal in accordance with the present invention is not limited to a bi-laminate construction and may include one or more additional layers disposed between the inner and outer layers as desired for a particular purpose or intended use.

As shown in FIGS. 1-4, the seal 10 includes an annular recess 40 extending about the circumference of the seal. The recess bifurcates the radial outer surface 14 so as to define a first sealing arm 42 adjacent the axial end face 16 and a second sealing arm 44 adjacent the axial end face 18. The height of the sealing arms may be defined by the distance d₁ from the lowest point of the recess to the radial outer surface 14. As shown in FIGS. 3 and 4, the recess has an angled U-shape such that the inner walls of the sealing arms 42 and 44 are disposed at an angle β relative to the radial axis Aᵣ. The angle β may be chosen as desired for a particular purpose or intended use. The angle β may be the same or different than the angle α that defines the angle of the end faces. It will be appreciated that the recess may be configured in any shape as desired including for example, a V-shape, a regular U-shape (such that the inner walls of the sealing arms are substantially parallel to the radial axis), a rectangle, a square, and the like.

The depth of the depression may also be chosen as desired for an intended application. In a seal having a multi-layered construction, the depression may be configured to extend through one or more of the layers. As shown in FIGS. 3 and 4, for example, the depression 40 extends through the outer layer 30 and into the inner layer 20. It will be appreciated that the depression may only partially extend into the outer layer (and not extend into the inner layer). Additionally, the depression may extend substantially through the entire outer layer but not extend into the inner layer.

A seal in accordance with the present invention is suitable for sealing a space between a first surface and a second surface. The seal is disposed about the first surface such that the radial inner surface of the seal engages the first surface. A seal member in accordance with the present invention is rollable such that one of the first and second axial end faces may be rolled toward and contacts the first surface. For example, the seal 10 includes edges 17 and 19 on the radial inner end 11. The seal is rollable about the edges 17 and 19, each of which may act as a fulcrum such that the seal pivots and one of the axial end faces rolls toward the first surface. Upon the seal rolling onto one of the axial end faces, the seal essentially reorients itself such that the opposite axial end face is oriented outwardly toward the second surface.

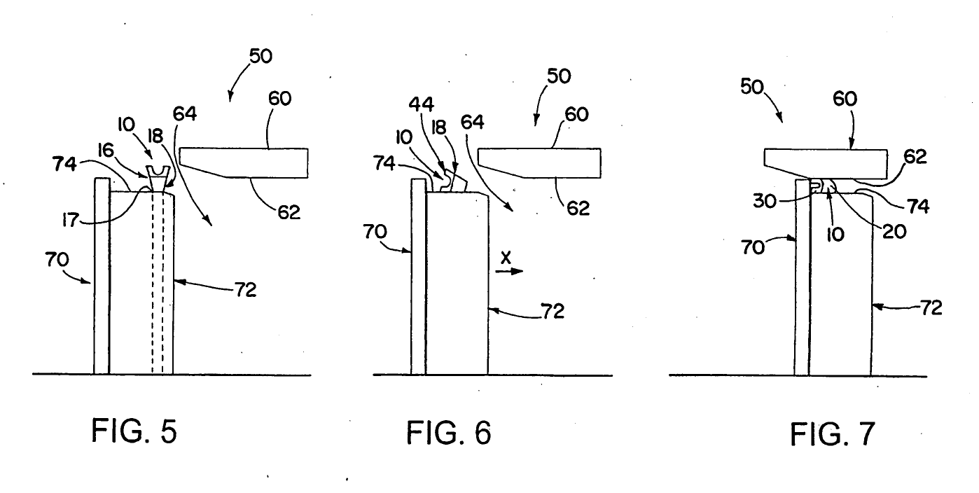

Referring again to the drawings, FIGS. 5-7 schematically illustrate the installation of a seal in accordance with the present invention into an assembly. As shown in FIGS. 5-7, an assembly 50 includes a member 60 having an surface 62. The part 60 may be, for example, a female part having a female part surface extending along a centrally longitudinal access and defining a bore 64. The assembly also includes a part 70 having a male part 72 with a male part surface 74 for insertion into the bore 64. The surface 74 of the male part 72 is radially spaced apart from the surface 62 of member 60 to define a space between the surface 62 and the surface 74.

Referring to FIG. 5, prior to moving member 70 and male part 72 into the bore, a seal, such as seal 10, may be attached to the male part 72. The seal 10 may be mounted on part 72 by stretching the seal and disposing the radial inner surface 12 about the surface 74 such that the radial inner surface of the seal engages the surface 74 of male part 72. In this initial mounting position, the radial outer surface 14 of the seal 10 is oriented toward the surface 62 of member 60.

Referring to FIGS. 6 and 7, the seal and member 70 are installed in the assembly by moving the male part 72 of member 70 into the bore (as indicated by arrow A). The seal 10 is rollable about an edge, e.g., edge 17, of the radial inner end. For example, as the seal is compressed, the edge 17 acts as a fulcrum and the seal pivots about edge 17 and the end face 16 is rolled toward and engages the surface 74 of part 72 (FIG. 6). As the end face 16 is rolled toward the surface 74, the end face 18 of the seal becomes oriented toward the surface 62 of the member 60. As shown in FIG. 7, as member 70 is moved toward the interior of the bore, the sealing arm 44 is deflected radially inward and at least a portion of the axial end surface 18 of the seal is compressed against and engages the surface 62 of the member 60. The installed seal provides a fluid seal between the surface 62 and the surface 74 at a first sealing interface between the surface 62 and the end face 18 of the seal and at a second sealing interface between the surface 74 and the end face 16 of the seal.

As discussed above, FIG. 6 illustrates the seal being rolled such that the end face 16 of the seal is in contact with the surface 74 of the part 72. Rolling of the seal may be accomplished by manually rolling the seal prior to and/or as the member 70 is moved toward the bore of member 60. The end face 16 may also be rolled toward the surface 74 by the compressive force placed on the seal when the radial outer surface of the seal, the edge of a sealing arm, and/or the end face 18, engage the surface 62 of the member 60 as the part 72 moves into the bore. The force placed against one or more of these surfaces cause the seal to rotate about a pivot point defined by an edge of the radial inner end.

In a seal having a multi-layered construction, each layer of the construction is exposed along the respective end faces. For example, referring back to FIGS. 1-4, the material of layers 20 and 30 are exposed along the surfaces of each of the axial end faces 16 and 18. Thus, referring again to FIGS. 6 and 7, when the seal is inserted into the assembly, the end face 16 engages the surface 74, and the materials of the inner and outer surface layers that are exposed along the surface of axial end face 16 each contact the surface 72 along the sealing interface. As the seal contacts the surface 62, the seal is compressed and the axial end face 18 engages the surface 62. The degree to which the seal is compress may depend on the thickness of the respective layers (e.g., inner layer 20 and outer layer 30), the materials used to form the respective layers, the cross-sectional area of the seal occupied by the annular depression, and/or the thickness of the sealing arms. The axial end face 18 may be compressed to a degree such that at least a portion of each layer exposed along the axial end face contacts the surface 62 along the sealing interface between the axial end face 18 and the surface 62. As shown in FIGS. 7, the seal is configured such that at least a portion of the outer layer 30 and the inner layer 20 (which are exposed along axial end face 18) is compressed against and contacts the surface 62 along the sealing interface between the surface of the end face 18 and the surface 62.

Applicants have found that a seal in accordance with the present invention having a multi-layered construction may provide a seal with multiple seal characteristics. Typically, a single material suitable for a seal may not provide all the desired characteristics for that seal. In a multi-layered seal construction in accordance with the present invention, the respective layers may be formed from materials that each provide a desired seal characteristic. Moreover, a multi-layered seal in accordance with the present invention may allow each material to be in a sealed engagement with the substrate surface at the seal interfaces. For example, when installed as described above with respect to FIGS. 5-7, the materials of both the inner and outer layers of the seal contact the surfaces 62 and 74 at (i) the sealing interface between end face 16 and surface 74, and (ii) the sealing interface between end face 18 and surface 62, thereby providing the seal characteristic exhibited by the respective layers at each sealing interface.

The materials used to form the seal may be selected as desired for a particular purpose or intended application. The materials may be selected to provide the seal with one or more desired characteristics for a particular application or intended use. The materials suitable for use in a desired application may be readily ascertainable by persons skilled in the art.

In an exemplary application, a seal may exhibit both low permeation to a selected fluid and good low temperature performance. Materials that exhibit low permeation include fluoropolymers, nylons, polyolefins (e.g., polyethylenes, polypropylenes, and the like), polyvinylchlorides (e.g., PVC), polysulfones, polyesters, vinyl polymers, arylics, and combinations of two or more thereof. Examples of suitable fluoropolymers include, but are not limited to, polyfluorotetraethylene (PFTE), expanded PFTE, perfluoroalkoxy polymer (PFA), fluorinated ethylene-propylene (FEP), polyvinylidene fluoride (PVDF), a terpolymer of tetrafluoroethylene, hexafluoropropylene and vinylidene fluoride (THV), polyethylenetetrafl uoroethylene (ETFE), polyethylenechlorotrifluoroethylene (ECTFE), fluoro rubber (FKM, e.g., vinylidene-hexafluoropropylene fluoro rubber copolymers), and perfluror rubbers (FFKM).

Materials that exhibit low temperature performance include various elastomeric materials. Suitable elastomers include natural rubber, synthetic rubbers such as nitrile rubber (e.g., NBR), hydrogenated nitrile rubber, silicone rubber, fluorosilicone rubber, acrylic rubber, butadiene rubber, butyl rubber, chlorobutyl rubber, and styrene butadiene rubber, thermoplastic elastomers including, for example, polyurethane, polyester, polyether ester, polyolefin, and combinations of two or more thereof.

The location of the materials may be selected as desired for a particular application. For example, it may be desirable to locate a low permeability material in the path of the fluid to form a permeation barrier. In an exemplary construction, a seal in accordance with the present invention is a multi-layered construction having an inner layer formed from a material having a permeability to a desired fluid lower than the permeability of the material forming the outer layer, and the outer layer may be formed from a material exhibiting low temperature performance.

Regardless of the location of the materials, when installed, a seal in accordance with the present invention provides both materials at each sealing interface. Referring back to FIG. 7, each of the layers 20 and 30 are in contact with each of the surfaces 62 and 74 along the sealing interfaces. Where layer 20 is formed from a low permeability material and layer 30 is formed from a material with good low temperature performance, the seal exhibits low permeability to a given fluid at each sealing interface. Additionally, the material with low temperature performance is also present at each sealing interface, which should reduce the likelihood of a fluid leaking at one of the interfaces.

A seal may be provided by forming a seal preform by extruding a polymeric material, or co-extruding two or more materials in the case of multi-layered constructions, to form an elongated structure and separating the elongated structure into axial sections. The elongated structure may have any shape as desired to provide a desired seal shape. For example, the elongated structure may be provided as an elongated tubular structure. The term “elongated structure,” including an elongated tubular structure, may include any elongated structure formed from the extrusion process and to any workpiece formed from the extruded elongated structure prior to being formed as a finished seal. An elongated tubular structure may have any shape as desired for a particular purpose or intended use including, but not limited to, circular, oval, elliptical, rectangular, square, triangular, and the like.

The extruded structure may be separated into axial sections by cutting through the tubular structure at an angle relative to the longitudinal axis of the tubular structure. The tubular structure may be cut at an angle perpendicular to the longitudinal axis of the structure (i.e., parallel to the radial axis) or at an angle other than perpendicular to the longitudinal axis to provide an angled axial end faces. The extruded elongated structure may be separated into seal structures using any suitable cutting tool such as a knife, blade, or the like.

The annular recess 40 may be provided by any suitable method such as, for example, a grinding process using a lathe and a grinding tool. The grinding tool may have a shape to provide the desired shape of the annular depression.

Although the invention has been shown and described with respect to one or more exemplary embodiments, it is appreciated that alterations and modifications may occur to others skilled in the art upon reading and understanding the specification and the annexed drawings without departing from the precepts involved herein. It is intended that all matter contained in the foregoing description shall be interpreted as illustrative and not in a limiting sense. In addition, while a particular feature may have been described with respect to only one or more several illustrated embodiments, such feature may be combined with one or more other features of the other embodiments, as may be desired and advantageous for any given or particular application.

1. A static or dynamic seal ring for installation within an assembly including a female part having a generally annular female part surface which extends along a central longitudinal assembly axis, and a male part having a generally cylindrical male part surface disposed in concentric opposition to the female surface, the part surfaces being radially spaced-apart to define a clearance gap therebetween, and the seal ring configured to be receivable in the gap coaxially with the assembly axis, the seal ring comprising an elastomeric body having a radial inner end defining a radial inner surface, a radial outer end defining a radial outer surface, a first axial end face, and a second axial end face, the radial inner end having a width narrower than the width of the radial outer end,
the seal, when its radial inner surface is disposed about the male part surface, is rollable about an edge of the radial inner end such that one of the first axial end face and the second axial end face is disposed against the male part surface, and the opposite axial end face is compressible against the female part surface.

2. The seal of claim 1, comprising an annular recess extending around the circumference of the seal and defining a first sealing arm and a second sealing arm.

3. The seal of claim 1, wherein the seal is a multi-layered construction comprising an inner layer and an outer layer adjacent the inner layer, the inner layer defining the radial inner surface, and the outer layer defining the radial outer surface.

4. The seal of claim 3, wherein the inner layer comprises a first material exhibiting a first seal characteristic, and the outer layer comprises a second material comprising a second seal characteristic.

5. The seal of claim 4, wherein the first material has a permeability for a given fluid lower than the permeability of the second material to the given fluid.

6. The seal of claim 5, wherein the first material comprises a fluoropolymer.

7. The seal of claim 4, wherein the second material provides the seal with a low temperature performance characteristic.

8. The seal of claim 7, wherein the second material comprises a material chosen from a natural rubber, a synthetic rubber, or a combination thereof.

9. The seal of claim 3, comprising an annular recess extending around the circumference of the seal and defining a first sealing arm and a second sealing arm.

10. The seal of claim 11, wherein the recess extends through the first layer into the second layer.

11. The seal of claim 1, wherein the first and second axial end faces independently define an angle of from about 20° to about 60° relative to a radial axis of the seal.

12. The seal of claim 11, wherein the first and second angles are the same.

13. The seal of claim 1, wherein the inner radial surface is received about the male surface part, and the seal is rolled such that one of the first and second axial end faces is disposed against the male surface part and the opposite axial end face is compressed against the female surface part.

14. The seal of claim 2, wherein the inner radial surface is received about the male surface part, the seal is rolled such that one of the first and second axial end faces is disposed against the male surface part, the opposite axial end face is compressed against the female surface part, and the seal arm adjacent the axial end face compressed against the female surface part is deflected radially inward.

15. The seal of claim 14, comprising an inner layer and an outer layer adjacent the outer layer, each of the respective layers being exposed along the first and second axial end faces, wherein the seal is compressed against the female surface part such that at least a portion of each the inner and outer layer is compressed against the female surface part.

16. The seal of claim 15, wherein the inner layer comprises a first material and the outer layer comprises a second material, the first material having a permeability to a given fluid that is lower than the permeability of second material to the given fluid.

17. A method of sealing a space between a female part having a generally annular female part surface which extends along a central longitudinal assembly axis, and a male part having a generally cylindrical male part surface disposed in concentric opposition to and radially spaced apart from the female surface, the method comprising installing the seal of claim 1 about the male surface part such that the radial inner surface is received about the male part surface, inserting the seal into the space between the female part surface and the male part surface, rolling seal about the edge of the radial end such that one of the first axial end surface and the second axial end surface is disposed against the male part surface, and compressing the opposite axial end face against the female part surface.
